(19) United States
(12) Patent Application Publication
(10) Pub. No.: US 2019/0353317 A1
(43) Pub. Date: Nov. 21, 2019

(54) Flameless Candle

(71) Applicant: Hsiu Kuang Chang, Guangdong (CN)

(72) Inventor: Hsiu Kuang Chang, Guangdong (CN)

(73) Assignee: Shun Tai Present Co., Ltd., Guangdong (CN)

(21) Appl. No.: 16/418,647

(22) Filed: May 21, 2019

Related U.S. Application Data
(60) Provisional application No. 62/674,282, filed on May 21, 2018.

(51) Int. Cl. F21S 10/04; F21S 19/00; F21S 6/00; F21S 9/02

(52) U.S. Cl. CPC F21S 10/04; F21S 19/00; F21W 2121/00; F21S 9/02; F21S 6/001

(57) ABSTRACT

A system and method for a flameless candle. The candle comprises a candle base and a lamp shade extending upward from the candle base. The lamp shade is shaped to form an internal cavity. Within the internal cavity is a core which has a plurality of LEDs. The core is electrically coupled to a power source such that, when powered, the LEDs can become illuminated and non-illuminated to resemble a dancing flame.

### PRIORITY

This application claims priority to Provisional Application No. 62/674,282 filed on May 21, 2018, the entirety of which is hereby incorporated by reference.

### BACKGROUND OF THE INVENTION

### Technical Field

The present invention relates to a system and method for using a flameless candle.

### Description of Related Art

Candles provide warmth, light, and often, a fragrance. However, candles can also be dangerous when accidentally tipped over or allowed to burn near flammable materials. Consequently, there is a need for a device which mimics the candle and has many of the benefits, but which is safer.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of the candle in one embodiment;

FIG. 2 is a perspective view of a candle with a visible core in one embodiment;

FIG. 3 is a perspective view of an illuminated LED in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

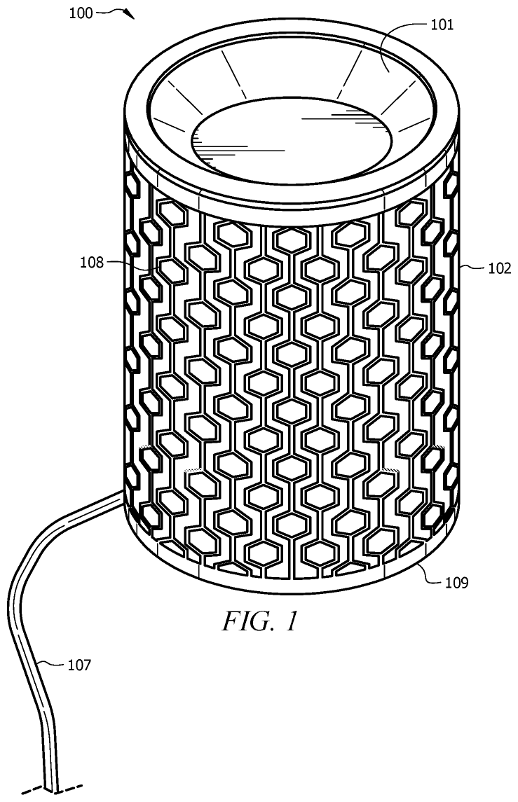

FIG. 1 is a perspective view of the candle in one embodiment. The candle 100 can comprise any flameless candle. As noted below, a flameless candle has many benefits. The flameless candle is safer as the risk of fire is drastically reduced. Further, candles have a limited duration of a few hours or days. Conversely, a flameless candle can last as long as the light source.

The size and dimensions of the candle 100 can vary depending upon a variety of factors. In one embodiment, and depicted in FIG. 1, the candle 100 comprises a circular cross-section. This is for illustrative purposes only and should not be deemed limiting. In other embodiments the candle 100 can comprise various other cross-sectional shapes such as triangular, rectangular, square, and other polygonal shapes.

The candle 100 comprises a lamp shade 102. In one embodiment a lamp shade 102 is at least partially translucent to allow light to pass from the internal side of the candle to the external side where it is visible. The lamp shade 102 can comprise virtually any material, including plastic, metal, wood, and combinations thereof. The color of the light source can be controlled by adjusting or controlling the color of the lamp shade 102.

In one embodiment the candle 100 is hollow, and the lamp shade 102 forms an internal cavity.

As depicted, and in some embodiments the lamp shade 102 comprises a structural element 108. The structural element 108 provides design and offers structure to the lamp shade 102. The structural element 108 can comprise virtually any shape. The structural element 108 is not present in some embodiments, but in other embodiments, the structural element 108 provides structure and stability to the candle.

The candle 100 further comprises a power source 107. The power source 107 can comprise virtually any power source, including but not limited to, batteries, solar panels, and the electrical grid. In one embodiment the candle 100 has a switch to turn the candle 100 from the on to the off position, and vice versa.

In one embodiment, the candle is also coupled to a dish 101. As depicted, the dish 101 is located atop the lamp shade 102. The dish 101 has at least a partially open top and a depth for housing a liquid. In one embodiment wax, oil, or other fragranced items can be placed within the dish 101. The heat produced by the candle 100 will act upon the dish 101 and cause the fragranced item to dispense its scent into the air. Essential oils and other items can be placed within the dish 101.

Though not depicted, in other embodiments the dish 101 comprises a top. This top protects the contents of the dish 101. In one embodiment the top has slits, holes, or other openings which allow the scent to disperse.

As depicted, the candle 100 further comprises a candle base 109. The base 109 has an outer peripheral ridge which secures the lamp shade 102 within the ridge. In one embodiment the base 109 is rigid.

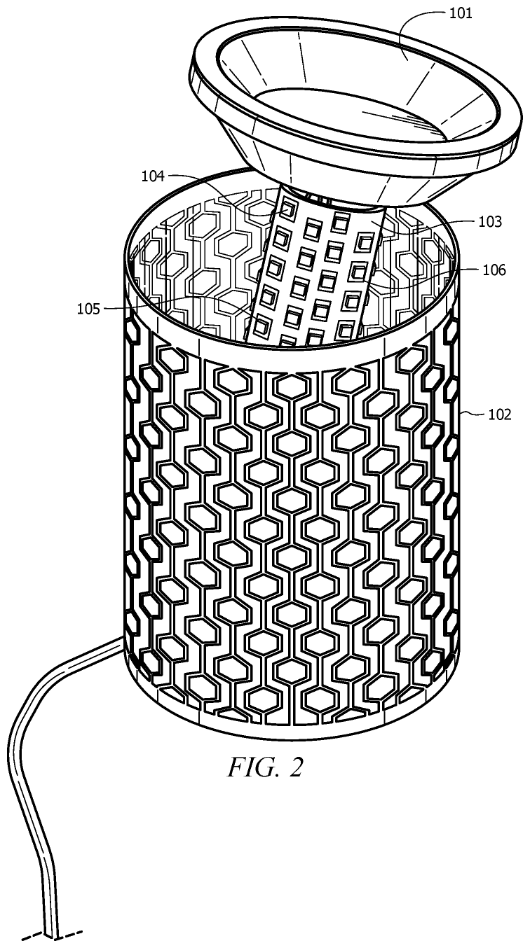

Turning now to FIG. 2, FIG. 2 is a perspective view of a candle with a visible core in one embodiment. The core 103 is housed within the cavity of the candle 100. As depicted, and in some embodiments, the core 103 is coupled to the dish 101. In one embodiment the dish 101 is coupled to the candle base 109 via a nut and bolt. As an example, a bolt is coupled to the dish 101 and extends through the core 103 and is inserted partially through a hole in the base 109 where it is secured via a nut. To remove the core 103, the nut is removed and the core 103 is allowed to be pulled upward relative to the stationary base 109.

As depicted, and in one embodiment, the core 103 extends longitudinally along the length (height) of the candle 100. In one embodiment the core 103 extends downward from the dish 101. In one embodiment the core 103 extends for greater than 50% of the height of the candle 100.

The core 103 can comprise virtually any cross-sectional shape. In one embodiment the core 103 comprises a cross-sectional shape which mimics the shape of the lamp shade 102. Thus, if the lamp shade 102 is circular, then the core 103 is likewise circular.

In one embodiment the outer effective diameter of the core 103 is smaller than the inner effective diameter of the lamp shade 102. In some embodiments the outer effective diameter of the core 103 is significantly less than the inner effective diameter of the lamp shade 102. As an example, in one embodiment the lamp shade 102 comprises an inner diameter of about 4 inches whereas the core 103 has an outer diameter of about one inch. Larger or smaller ratios of diameters can be utilized. Having a core with a smaller diameter results in few LEDs being used, whereas having a core with a larger diameter can require additional LEDs given the increased circumference and associated surface area.

In one embodiment the core comprises a core diameter, and wherein said lamp shade comprises an inner lamp shade diameter, and wherein the ratio of said core diameter to said inner lamp shade diameter is between about 1:1.5 and about 1:5. As an example, in one embodiment the ratio is approximately 1:4.

In one embodiment there is a separation between the core 103 and the lamp shade 102. This distance allows the light source to appear as a flame as opposed to discrete LEDs. The size of the separation can vary depending upon the type of lamp shade 102 utilized.

In one embodiment the separation between the core 103 and the lamp shade 102 is greater than the diameter of the core 103. In one embodiment, the separation between the core 103 and the lamp shade 102 is greater than the radius of the core 103.

The core 103 comprises a plurality of lights sources. In one embodiment the light sources comprise LEDs. While the application discusses LEDs, this is for illustrative purposes only and should not be deemed limiting.

The core 103 comprises several LEDs 104 located on the outside diameter of the core 103. The LEDs 104 are spaced so that various LEDs can light up at different times, so the resulting image on the external side of the lamp shade 102 resembles the dancing flame of a candle. Thus, in one embodiment each LED, or light source, can be independently controlled and switched from illuminated to non-illuminated. This allows the candle to better mimic the shape and movement of a flame.

In one embodiment a plurality of LEDs are spaced along the entire circumference of the core 103. This allows the lights to be viewed on all sides of the candles. Put differently, a user does not need to be standing on a specific side to view the light but can view the light from any angle relative to the candle 100.

As depicted, the LEDs 104 are organized in several vertical columns 106 spaced apart along the circumference of the core 103. The number of columns 106 and spacing will vary depending upon the size of the core 103. For larger cores, there will generally be more columns 106.

The LEDs, in some embodiments, are also ordered along diagonal lines 105. This diagonal configuration allows the lights to better mimic a flame.

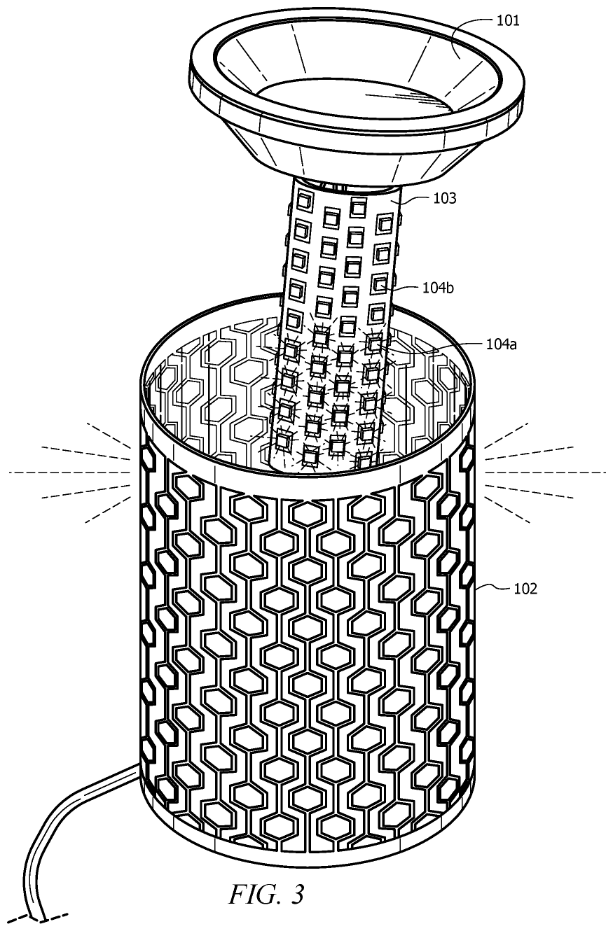

Turning now to FIG. 3, FIG. 3 is a perspective view of an illuminated LED in one embodiment. As can be seen, several LEDs 104 are illuminated while other LEDs 104b are not illuminated. Varying the number and location of the illuminated LEDs as well as the non-illuminated LEDs 104b control the location of the light and allows for the shape of a dancing flame to be better mimicked.

Because the LEDs are spaced in various locations, certain LEDs can be illuminated to mimic the presence of a flame. When the flame moves, previously illuminated LEDs become non-illuminated LEDs.

Which LEDs are illuminated, and for how long, can be controlled in a variety of methods. In one embodiment an electrical panel comprises a series of switches to allow and control the illumination of the LEDs. In other embodiments the LEDs are controlled by a chip. The chip can be programed to result in an LED illumination which resembles a flame.

In FIG. 3, the core 103 is partially removed to allow the various LEDs, illuminated and non-illuminated, to be seen. In operation, however, the core 103 is not visible. Instead, the light is only seen through the lamp shade 102. This adds to the illusion that there is a dancing flame within the lamp shade 102.

There are several benefits of the system and method discussed herein. First, in some embodiments, the system utilizes LEDs. LEDs are often superior to other light sources because they consume far less energy. Further the LED bulbs generally far outlast other bulbs, such as traditional light bulbs which much be routinely replaced. LEDs can last a year or even several years. Thus, the vast benefits of an LED light source, are applicable to the system disclosed herein.

A second benefit is the ability to mimic the look and appearance of the flame with a plurality of LEDs. Because the LEDs turn off and on, they give the appearance that the flame is flickering. Rather than a static and steady light source, the light projected onto the lamp shade 102 appears to move randomly like a real flame. Thus, the ambiance of a real flame is captured with a plurality of LEDs.

A third benefit is the ability to capture and utilize the heat provided by the LEDs. LEDs generally give off less heat than traditional bulbs. However, as noted, the LEDs are organized and stored on a central core. The heat generated by the LEDs is allowed to dissipate and rise upward to the dish 101. The heat directed to the dish 101 can be utilized to melt wax, warm scented liquid, etc. This allows a scent to be released and provide fragrance for the surrounding area.

A fourth benefit is increased safety compared to an open flame. While consumers often prefer the flickering of a flame to a static light source, an open flame often presents fire and burn dangers. The system discussed herein drastically reduces the potential for damage due to a fire or a burn, yet retains many of the benefits of a candle with a flame.

While the invention has been particularly shown and described with reference to a preferred embodiment, it will be understood by those skilled in the art that various changes in form and detail may be made therein without departing from the spirit and scope of the invention.

What is claimed is:

1. A system for a flameless candle, said system comprising:
a candle base;
a lamp shade extending upward from said candle base, wherein said lamp shade is shaped to form an internal cavity;
a core located within said internal cavity, wherein said core comprises a plurality of light sources;
wherein said core is electrically coupled to a power source.

2. The system of claim 1 further comprising a dish located atop said lamp shade.

3. The system of claim 1 wherein said flameless candle has a circular cross-section.

4. The system of claim 1 wherein said lamp shade is partially translucent.

5. The system of claim 1 wherein said lamp shade comprises a structural element.

6. The system of claim 2 wherein said core is coupled to said dish.

7. The system of claim 2 wherein said dish is coupled to said base.

8. The system of claim 7 wherein said dish is coupled to said base via a bolt.

9. The system of claim 1 wherein said flameless candle comprises a height, and wherein said core extends longitudinally along the height.

10. The system of claim 9 wherein said core extends greater than 50% of the height of the flameless candle.

11. The system of claim 1 wherein said core comprises a core diameter, and wherein said lamp shade comprises an inner lamp shade diameter, and wherein the ratio of said core diameter to said inner lamp shade diameter is between about 1:1.5 and about 1:5.

12. The system of claim 1 further comprising a separation between said core and said lamp shade, and wherein said separation comprises an empty void.

13. The system of claim 1 wherein said plurality of light sources comprises a plurality of LEDs.

14. The system of claim 1 wherein said core comprises a circumferential perimeter, and wherein said light sources are organized in several vertical columns spaced apart along the circumferential perimeter of the core.

15. The system of claim 14 wherein said light sources are further ordered along diagonal lines.

16. The system of claim 1 wherein said plurality of light sources further comprises a plurality of illuminated light sources, and a plurality of non-illuminated light sources.

17. The system of claim 1 wherein each of said light sources can be independently illuminated and non-illuminated to mimic a dancing flame.
